(19) United States
(12) Patent Application Publication
(10) Pub. No.: US 2024/0249337 A1
(43) Pub. Date: Jul. 25, 2024

(54) SYSTEMS AND METHODS FOR MULTI-TASK AND MULTI-SCENE UNIFIED RANKING

(71) Applicants: Baidu USA, LLC, Sunnyvale, CA (US); Baidu.com Times Technology (Beijing) Co., Ltd., Beijing (CN)

(72) Inventors: Shulong TAN, Mountain View, CA (US); Meifang LI, Shanghai (CN); Weijie ZHAO, Sunnyvale, CA (US); Yandan ZHENG, Shanghai (CN); Xin PEI, Beijing (CN); Ping LI, Bellevue, WA (US)

(73) Assignees: Baidu USA LLC, Sunnyvale, CA (US); Baidu.com Times Technology (Beijing) Co., Ltd., Beijing (CN)

(21) Appl. No.: 18/557,922

(22) PCT Filed: Oct. 15, 2021
(86) PCT No.: PCT/CN2021/124174

§ 371 Date: Oct. 27, 2023

(51) Int. Cl. G06Q 30/0601

(52) U.S. Cl. CPC G06Q 30/0631

(57) ABSTRACT

Information recommendation system usually involve a multitask problem, which tries to predict not only users' click-through rate (CTR) but also the post-click conversion rate (CVR). At the same time, for multi-functional information systems, there are commonly multiple services for users, such as news feed, search engine, and product suggestions. The prediction/ranking model should be conducted in a multi-scene manner. In the present patent document, embodiments of a unified ranking model for such a multi-task and multi-scene problem are disclosed. The disclosed model explores independent and non-shared embeddings for each task and scene, which reduces the coupling between tasks and scenes. Therefore, new tasks or scenes may be added easily. Besides, a simplified network may be chosen beyond the embedding layer, which largely improves the ranking efficiency for various online services. Extensive offline and online experiments demonstrated the superiority of model embodiments.

### TECHNICAL FIELD

The present disclosure relates generally to systems and methods for computer learning that can provide improved computer performance, features, and uses. More particularly, the present disclosure relates to systems and methods for multi-task and multi-scene ranking.

### BACKGROUND

Deep neural networks have achieved great successes in many domains, such as computer vision, natural language processing, recommender systems, etc.

Information retrieval and content delivery (e.g., recommender systems) usually pose a multitask problem, which tries to predict not only relevance to a user (which may be gauged in terms of users' click-through rate (CTR)) but also the post-click conversion rate (CVR). At the same time, for multi-functional information systems, there are commonly multiple services for users, such as news feed, search engine, and product suggestions.

Accordingly, what is needed are systems and methods for multi-task and multi-scene ranking.

### SUMMARY

According to a first aspect, some embodiments of the present disclosure provide a computer-implemented method to train a ranking model for information recommendation in a multi-task and multi-scene (MTMS) setting, the method includes: receiving, at the ranking model, a training dataset across multiple scenarios, the training dataset comprises input data in multiple fields across multiple scenarios and results associated with multiple tasks; generating, using multiple neural networks within the ranking model, embeddings independently for input data in each field for each task under each scenario; combining embeddings across the multiple scenarios to generate a combined embedding; generating, using multiple cross-scene ranking neural networks within the ranking model, multi-scene task predictions for the multiple tasks under the multiple scenarios, each cross-scene ranking neural network receives the combined embedding to generate a multi-scene task prediction for one task under one scenario; obtaining an MTMS prediction based at least on each multi-scene task prediction; and training the ranking model using an MTMS loss function, the MTMS loss function comprises at least loss terms associated with each task.

According to a second aspect, some embodiments of the present disclosure provide a computer-implemented method for training a ranking model, the method includes: initializing embeddings of each feature field for each task under each scenario in a multi-task and multi-scene (MTMS) setting; updating, until a stop condition is met, parameters of multiple neural networks within the ranking model with a training dataset to update embeddings across the multiple scenarios, the training dataset comprises input data in multiple fields under multiple scenarios and results associated with multiple tasks for each scenario; combining the updated embeddings across multiple tasks and across the multiple scenarios to generate a combined embedding for each task under each scenario; generating, multiple cross-scene ranking neural networks within the ranking model, multi-scene task predictions, each cross-scene ranking neural network receives one combined embedding for one task under one scenario to generate a multi-scene task prediction for the one task; and training the ranking model using an MTMS loss function, the MTMS loss function comprises at least loss terms associated with each task.

According to a third aspect, some embodiments of the present disclosure provide a non-transitory computer-readable medium or media comprising one or more sequences of instructions which, when executed by at least one processor, causes steps for training a ranking model for information recommendation in a multi-task and multi-scene (MTMS) setting comprising: receiving, at the ranking model, a training dataset across multiple scenarios, the training dataset comprises input data in multiple fields under multiple scenarios and results associated with multiple tasks; generating, using multiple neural networks within the ranking model, embeddings independently for input data in each field for each task under each scenario; combining embeddings for each task across the multiple scenarios to generate multiple combined embeddings, each combined embedding corresponds to one task under one scenario; generating, using multiple cross-scene ranking neural networks within the ranking model, multi-scene task predictions for the multiple tasks under the multiple scenarios, each cross-scene ranking neural network receives one combined embedding to generate one multi-scene task prediction for one task under one scenario; obtaining an MTMS prediction based at least on the multi-scene task predictions; and training the ranking model using an MTMS loss function, the MTMS loss function comprises loss terms associated with each task.

### BRIEF DESCRIPTION OF THE DRAWINGS

References will be made to embodiments of the disclosure, examples of which may be illustrated in the accompanying figures. These figures are intended to be illustrative, not limiting. Although the disclosure is generally described in the context of these embodiments, it should be understood that it is not intended to limit the scope of the disclosure to these particular embodiments. Items in the figures may not be to scale.

FIG. 1 depicts a framework of a multi-task and multi-scene (MTMS) unified ranking model, according to embodiments of the present disclosure.

FIG. 2 depicts an entire space multi-task model (ESMM) with CTR and CVR sharing embedding, according to embodiments of the present disclosure.

FIG. 3 graphically depicts an MTMS model for embedding update without embedding sharing, according to embodiments of the present disclosure.

FIG. 4 depicts a process for embedding update, according to embodiments of the present disclosure.

FIG. 5 graphically depicts an MTMS model for network fine tuning, according to embodiments of the present disclosure.

FIG. 6 depicts a process for network fine tuning, according to embodiments of the present disclosure.

FIG. 7 depicts a simplified block diagram of a computing device/information handling system, according to embodiments of the present disclosure.

### DETAILED DESCRIPTION OF EMBODIMENTS

In the following description, for purposes of explanation, specific details are set forth in order to provide an understanding of the disclosure. It will be apparent, however, to one skilled in the art that the disclosure can be practiced without these details. Furthermore, one skilled in the art will recognize that embodiments of the present disclosure, described below, may be implemented in a variety of ways, such as a process, an apparatus, a system, a device, or a method on a tangible computer-readable medium.

Components, or modules, shown in diagrams are illustrative of exemplary embodiments of the disclosure and are meant to avoid obscuring the disclosure. It shall be understood that throughout this discussion that components may be described as separate functional units, which may comprise sub-units, but those skilled in the art will recognize that various components, or portions thereof, may be divided into separate components or may be integrated together, including, for example, being in a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” “communicatively coupled,” “interfacing,” “interface,” or any of their derivatives shall be understood to include direct connections, indirect connections through one or more intermediary devices, and wireless connections. It shall also be noted that any communication, such as a signal, response, reply, acknowledgement, message, query, etc., may comprise one or more exchanges of information.

Reference in the specification to “one or more embodiments,” “preferred embodiment,” “an embodiment,” “embodiments,” or the like means that a particular feature, structure, characteristic, or function described in connection with the embodiment is included in at least one embodiment of the disclosure and may be in more than one embodiment. Also, the appearances of the above-noted phrases in various places in the specification are not necessarily all referring to the same embodiment or embodiments.

The use of certain terms in various places in the specification is for illustration and should not be construed as limiting. A service, function, or resource is not limited to a single service, function, or resource; usage of these terms may refer to a grouping of related services, functions, or resources, which may be distributed or aggregated. The terms “include,” “including,” “comprise,” “comprising,” or any of their variants shall be understood to be open terms, and any lists of items that follow are example items and not meant to be limited to the listed items. A “layer” may comprise one or more operations. The words “optimal,” “optimize,” “optimization,” and the like refer to an improvement of an outcome or a process and do not require that the specified outcome or process has achieved an “optimal” or peak state. The use of memory, database, information base, data store, tables, hardware, cache, and the like may be used herein to refer to system component or components into which information may be entered or otherwise recorded. A set may contain any number of elements, including the empty set.

In one or more embodiments, a stop condition may include: (1) a set number of iterations have been performed; (2) an amount of processing time has been reached; (3) convergence (e.g., the difference between consecutive iterations is less than a first threshold value); (4) divergence (e.g., the performance deteriorates); (5) an acceptable outcome has been reached; and (6) all of the data has been processed.

One skilled in the art shall recognize that: (1) certain steps may optionally be performed; (2) steps may not be limited to the specific order set forth herein; (3) certain steps may be performed in different orders; and (4) certain steps may be done concurrently.

Any headings used herein are for organizational purposes only and shall not be used to limit the scope of the description or the claims. Each reference/document mentioned in this patent document is incorporated by reference herein in its entirety.

It shall be noted that any experiments and results provided herein are provided by way of illustration and were performed under specific conditions using a specific embodiment or embodiments; accordingly, neither these experiments nor their results shall be used to limit the scope of the disclosure of the current patent document.

It shall also be noted that although embodiments described herein may be within the context of information recommendation or retrieval, such as online advertisement recommendation, aspects of the present disclosure are not so limited. Accordingly, aspects of the present disclosure may be applied or adapted for use in other contexts.

### A. General Introduction

To train proper ranking models for information recommendation or retrieval, such as online advertising or recommending, it is vital to make use of sequential user actions. For example, a typical sequential pattern of user actions for recommended information, e.g., advertising, is impression→click→conversion: 1) a user sees recommended information, e.g., an advertisement; 2) the user has a response to the recommended information, e.g., the advertisement is clicked; and 3) the user has a transaction, e.g., purchasing, subscribing, or registering for a product or service, associated with the recommended information. User actions for impression→click may be used for predicting a first indicator, e.g., users' click-through rate (CTR), that indicates a successful rate of a first task of promoting users to respond (click) to the recommended information. The click→conversion data is used for prediction of a second indicator, e.g., post-click conversion rate (CVR), that indicates a successful rate of a second task of promoting users to have a transaction corresponding to the recommended information. To model CVR in the entire impression space, previous work tries to predict an overall indicator, which may be a combination of the first indicator and the second indicator. In one or more embodiments, the overall indicator may be an indicator CTCVR, what is a product (CTR×CVR) of CTG and CVR. As described above, the learning-to-rank problem is naturally a multi-task problem.

Some popular information systems, such as Google and Facebook, may provide users multiple services, such as search engine, news feed and video stream. Users leave action data across all these scenarios, which shares similar user interest information. For each service scenario, action data may be too sparse to train robust ranking models, well known as cold start. It would be beneficial to train ranking models for all these services together and let them help each other to converge well, i.e., multi-scene learning.

Embodiment of the present patent disclosure focus on the multi-task and multi-scene ranking problem for information presentation and/or recommendation, e.g., online advertising. There are at least two main challenges to build a unified ranking model for such a multi-task and multi-scene ranking problem: 1) Data imbalance; the conversion rate is usually very low, e.g. 1%, and the training data for CVR is very sparse, comparing with that for CTR. It has been observed that, if CTR and CVR are trained together, the model may be largely biased to CTR and the performance of CVR may be negatively impacted. 2) Component coupling. For multi-task or multi-scene ranking models, shared embeddings across tasks and scenes are usually exploited. The advantage of this methodology is reducing the data sparsity for some tasks or scenes. However, it may become quite challenging to train the model since it has strong coupling across different components. The issue may get worse if more service scenarios, e.g., more than 10 (or even more than 100), get involved.

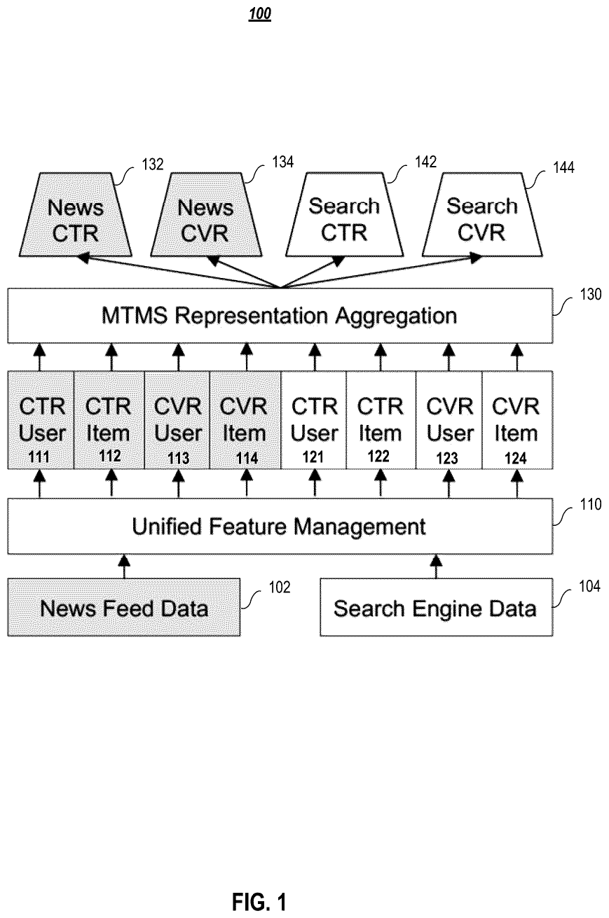

To overcome these challenges, embodiments of a unified ranking model for the multi-task and multi-scene ranking task are disclosed in the present patent disclosure. FIG. 1 depicts a framework of an MTMS unified ranking model, according to embodiments of the present disclosure. Different from previous related models, independent embeddings for each prediction task are exploited in each service scenario in the presented MTMS unified ranking model. As shown in FIG. 1, data corresponding to multiple service scenarios, e.g., news feed data 102 and search engine data 104, are utilized to generate a plurality of feature representations or embeddings for each task under each service scenario. A task may be presented as an indicator, e.g., a first indicator CTR or a second indicator CVR. The generated feature representations or embeddings for a service scenario may comprise embeddings across multiple fields, e.g., user side, item side, or both sides. As shown in FIG. 1, news feed data 102 are used to generate embeddings for the first service scenario comprising embedding 111 for the first task on a first field (user side), embedding 112 for the first task on a second field (item side), embedding 113 for the second task on a first field, and embedding 114 for the second task on a second field. Similarly, search engine data 104 are used to generate embeddings for the second service scenario comprising embedding 121 for the first task on a first field (user side), embedding 122 for the first task on a second field (item side), embedding 123 for the second task on a first field, and embedding 124 for the second task on a second field. In one or more embodiments, the input data for the multiple service scenarios are received at a unified feature management module 110 such that a unified embedding layout or dimension may be designated for the plurality of embeddings for each task under each service scenario. In one or more embodiments, the unified feature management module may also be designated to store and/or share the embeddings. Embeddings for each task under the first service scenario and embeddings for each task of the second service scenario are generated separately and independently, such that couplings between each task and between each service scenario may be reduced.

In one or more embodiments, the generated embeddings across the multiple tasks and multiple service scenarios are aggregated, in a MTMS representation aggregation module 130, to form an aggregated embedding, which is used by various ranking networks across ranking tasks for multiple service scenarios. As shown in FIG. 1, the ranking networks may comprise a ranking network 132 to generate a first indicator (CTR) prediction for the first service scenario (news feed), a ranking network 134 to generate a second indicator (CVR) prediction for news feed, a ranking network 142 to generate a CTR prediction for the second service scenario (search engine), a ranking network 144 to generate a CVR prediction for search engine, etc.

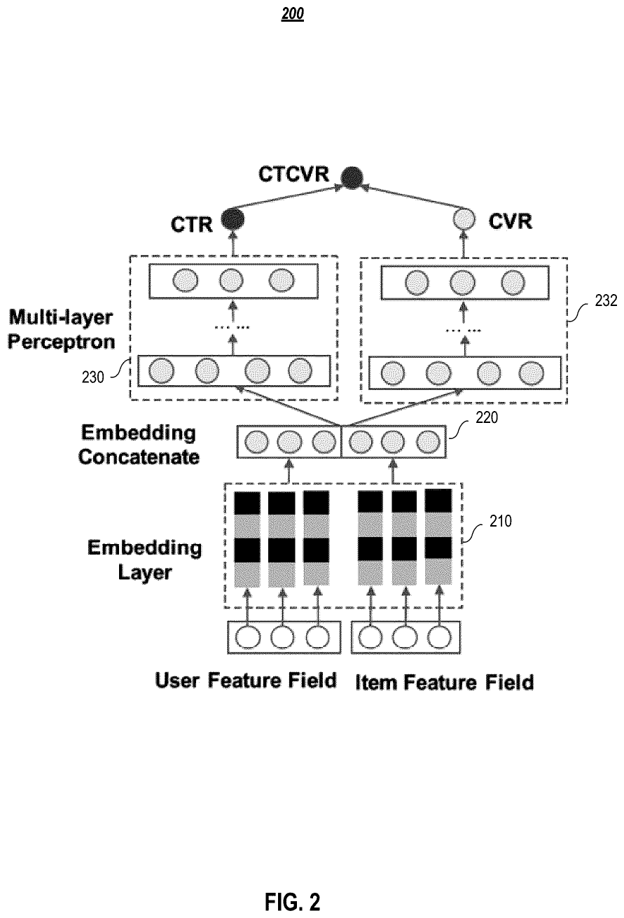

It shall be noted that the methodology embodiment shown in FIG. 1 may be simpler than previous models and may be easily extended for more tasks and more service scenarios. In one or more embodiments, for loss function, the second indicator (CVR) may be modeled explicitly instead of being considered as an intermediate variable (as in ESMM shown in FIG. 2). In one or more embodiments of the present disclosure, a loss function may be presented as a combination (e.g., a sum) of a CTR loss, a CVR loss, and a CTCVR (CTR×CVR) loss. In this way, the performance of CVR will not be hurt by auxiliary tasks. As introduced above, shared embeddings may alleviate the data sparsity issue for some tasks or scenes, such as the CVR prediction.

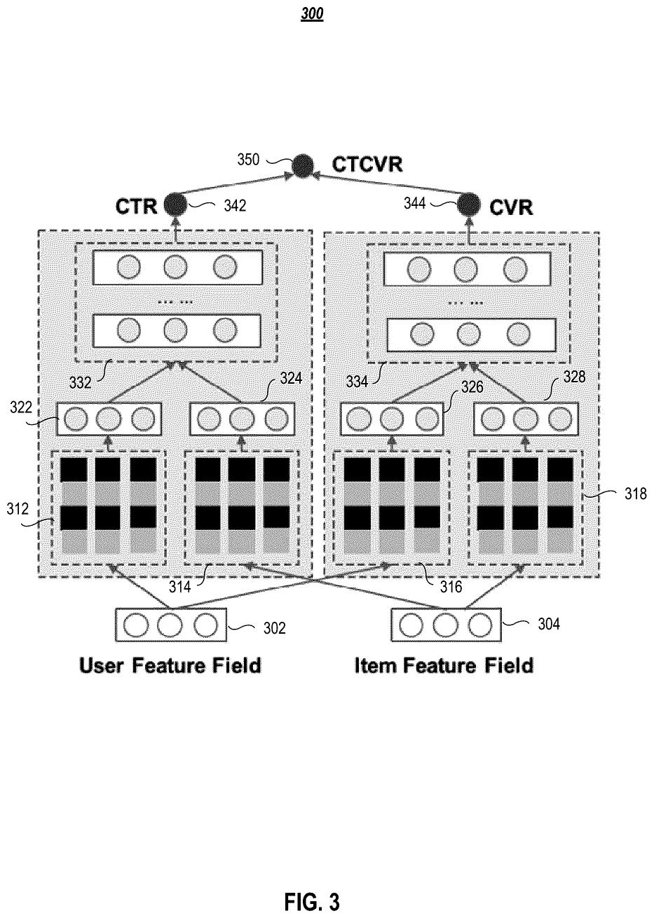

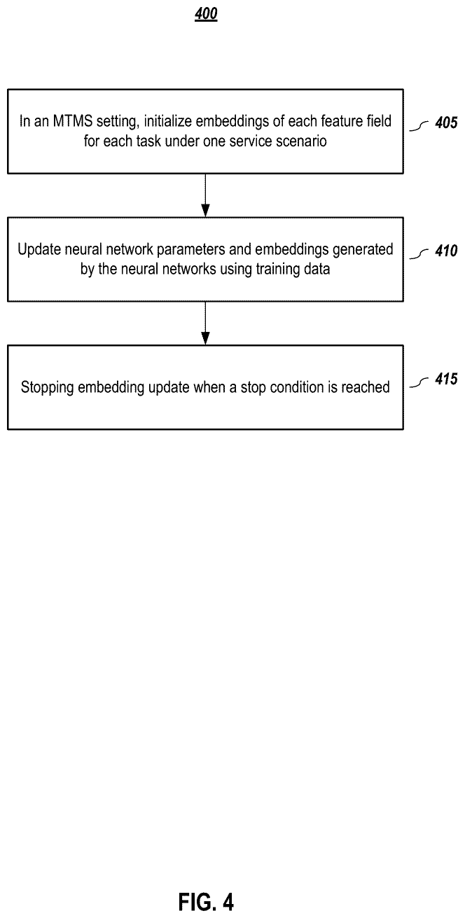

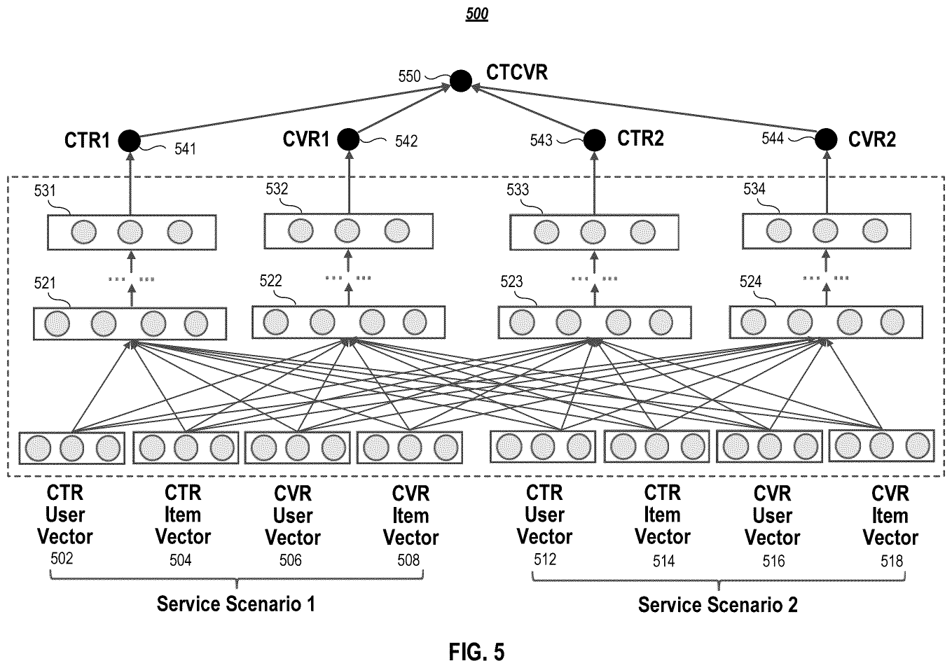

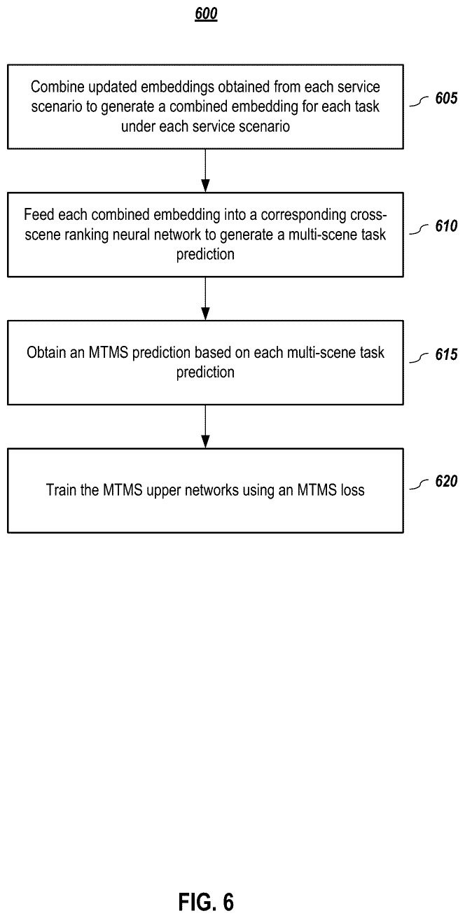

In the present patent disclosure, the data sparsity and cold start problem may be solved in a different way: the model training process is considered as an alternate update process based on sequence historical data, as graphically shown in FIG. 3 and FIG. 5. Further details of the alternate update process are described in subsection B.3. In one or more embodiments, for a current time slot T, the training process may comprise two steps: (1) Update parameters of neural network models for embedding update as shown in FIG. 3 and FIG. 4. Different tasks and scenarios do not share embeddings at this step. Since the models are loosely dependent to each other, it is easier to update the models for embedding generation to convergence. (2) Using updated embeddings from the previous embedding update step to fine-tune the ranking networks, as shown in FIG. 5 and FIG. 6. In this step, embeddings are aggregated and used across multiple ranking tasks and service scenarios. In this way, different models may help each other to reduce the data sparsity and the cold start problem.

In summary, contributions of the present patent disclosure include at least the following:

(1) Embodiments of a unified ranking model are disclosed for multi-task and multi-scene online advertising. The unified ranking model exploits independent embeddings for each ranking task in each service scenario. Since the component coupling of the unified ranking model is low, the model may be easy to be extended for more ranking tasks or more service scenarios.

(2) Embodiments of an alternate update strategy are disclosed for model training. To ease the training, an embedding update step focuses on updating parameters of neural network models for embedding generation to learn representations or embeddings. The fine tuning step only updates the ranking networks with fixing embeddings or parameters of the neural network models for embedding generation.

### B. Embodiments of a MTMS Unified Ranking Model

In this section, embodiments of an MTMS unified ranking model are presented. After a general methodology introduction, some elements of the presented MTMS unified ranking model, including loss function selection and the alternative update process, are disclosed.

### 1. General Methodology

Multi-task learning has become the main methodology for online advertising and recommendation recently. The target of multi-task learning is utilizing training data from different tasks and training all single task models together. In real scenarios, it is usually difficult to let tasks help each other positively. The performance may be sensitive to some task-specific factors, such as the differences in data distribution and relationships among tasks. Because of the conflicted and competitive task correlations, multi-task learning may lead to performance deterioration, also called negative transfer.

Shared-bottom multi-task Deep Neural Network (DNN) models are commonly adopted. The representation learning layers 210 are shared across all the tasks and then concatenated into a concatenated embedding 220. Each task, e.g., CTR or CVR, has an individual “tower” of network, e.g., 230 or 232, on top of the concatenated representation, such as the ESMM shown in FIG. 2. For this methodology, it was found that the performance of one task is often improved by hurting the performance of some other tasks. To study the proper trade-off between task-specific objectives and inter-task relationships, researchers try to exploit shared/non-shared expert networks and gating networks in multi-task learning models. Some proposes a Multi-gate Mixture-of-Experts (MMoE) structure based on Mixture-of-Experts (MoE) models. MMoE explicitly models the task relationships and learns task-specific functionalities to leverage shared representations by multiple gating networks. Differently, progressive layered extraction (PLE) model explicitly separates shared and task-specific experts to alleviate harmful parameter interference between common and task-specific knowledge.

These models work well in some simple scenarios, e.g., only two or three model components. In certain applications, there may be more than one hundred service scenarios and each scenario has multiple ranking tasks. It becomes not realistic to train proper models by expert and gating networks. In one or more embodiments of the present patent disclosure, a dynamically different design methodology, Multi-Task and Multi-Scene (MTMS) unified ranking model as shown in FIG. 1, are presented. In one or more embodiments, feature representations/embeddings for each service scenario and each ranking task are separately trained. Features for different service scenarios may have quite different distributions. Therefore it does not make sense or at least challenging, to share feature representations across these model components. In one or more embodiments, to connect different model components and let them help each other in model training, an alternative update process is adopted. Although the embeddings are trained separately in the embedding updating procedure, they may be aggregated and used for ranking model fine tuning across multiple service scenarios and ranking tasks. In this way, a model component may be benefited from other components while the inter-component negative transfer may be suppressed. Comparing with MMOE and PLE introduced above, embodiments of the present MTMS model are easy to be extended for more service scenarios and ranking tasks. As shown in the embodiment in FIG. 1, two service scenarios (i.e., news feed and search engine) and two ranking tasks for each service are considered. In a real system, there may be much more service scenarios instead of two. Furthermore, the presented MTMS model may have much simpler ranking networks which may be more efficient for online services.

### 2. Embodiments of a Multi-Task Loss Function

Notations: Let S=(xᵢ, yᵢ, zᵢ)|ᵢ₌₁^{N} be a whole dataset. x is the feature vector for observed impressions for recommended information, which usually contains multi-fields, from the user side, the item side, or both sides; y and z are binary labels, which indicate whether a user responses (e.g., clicks) to the recommended information and whether a conversion happens respectively. For certain information recommendation applications, such as online advertising, there are three key indicators or probabilities: 1) a first indicator, e.g., the post-view click though rate, CTR=p(y=1|x); 2) a second indicator, e.g., the post-click conversion rate, CVR=p(z=1|y=1,x); and 3) a joint indicator or joint probability based on the first and second indicators, e.g., the post-view and post-click conversion rate, CTCVR=CTR×CVR=p(y=1, z=1|x). Among these three probabilities, CVR is usually the key number to predict. Especially in certain applications such as optimized cost-per-click (OCPC) advertising, CVR is predicted for adjusting bid price per click to achieve better earning performance.

CVR prediction may be challenging since the conversion data is usually very sparse, which makes the CVR model fitting difficult. There are several studies that tackle this problem. The oversampling method copies rare class examples to relieve the data sparsity. Some proposed hierarchical estimators on different features to solve the problem. Multi-task learning is another idea to train CVR model with other auxiliary tasks together. For example, ESMM considers CTR as an auxiliary task, as shown in FIG. 2. CVR networks shares feature representations (embeddings) with CTR networks, to solve the data sparsity problem in CVR prediction. In ESMM, CVR is designed as an intermediate variable and CTCVR (CTR×CVR) is used as a part of prediction target together with CTR:

$${L}_{E S M M} = {L}_{C T R} ( {θ}_{ctr} ) + {L}_{C T C V R} ( {θ}_{ctr} , {θ}_{cvr} ) \qquad ( 1 )$$

In Equation (1), θ_{ctr} and θ_{cvr} are parameters of CTR and CVR neural models. The first part of loss function is CTR loss Σᵢ₌₁^{N}l(yᵢ, f(xᵢ: θ_{ctr})) and the second part is a joint loss (CTCVR loss) Σᵢ₌₁^{N}l(yᵢ&zᵢ, f(xᵢ:θ_{ctr})×f(xᵢ:θ_{cvr})).

It has been found that when the training data for CVR is very sparse and the CVR, area under the receiver operating characteristic (ROC) curve (AUC) level is relatively low, the ESMM model works well. An ROC curve shows the performance of a classification model at all classification thresholds. AUC is a measure of the usefulness of a test in general, where a greater area means a more useful test, the areas under ROC curves are used to compare the usefulness of tests. The CTR task may help CVR prediction and the CVR model may fit much easier, comparing to the single task manner. However, when the training data for CVR becomes rich and the AUC is high, the CTR task may hurt the CVR prediction. By running the ranking system longitudinally, richer and richer CVR training data may be collected and the CVR AUC may have a relatively high value. In one or more embodiments of the present patent disclosure, instead of treating the second indicator CVR as an intermediate variable as in ESMM, prediction of the second indicator CVR is explicitly modeled in the following MTMS loss function:

$${L}_{M T M S} = {L}_{C T R} ( {θ}_{ctr} ) + {L}_{C V R} ( {θ}_{cvr} ) + {L}_{C T C V R} ( {θ}_{ctr} , {θ}_{cvr} ) \qquad ( 2 )$$

In the MTMS loss function L_{MTMS}, the second term L_{CVR}(θ_{cvr}) is the CVR loss Σᵢ₌₁^{N}l(zᵢ, f(xᵢ:θ_{cvr})), which is a loss between the ground truth of user CVR in the training dataset and a prediction f(xᵢ: θ_{cvr}) of user action from the CVR neural network. L_{CTR} (θ_{ctr}) is a loss Σᵢ₌₁^{N}l(yᵢ, f(xᵢ: θ_{ctr})) between the ground truth of user CTR in the training dataset and a prediction of user action from the CTR neural network. The third loss term L_{CTCVR} (θ_{ctr}, θ_{cvr}) is Σᵢ₌₁^{N}l(yᵢ&zᵢ, f(xᵢ: θ_{ctr})×f(xᵢ: θ_{cvr})), which is a joint loss between the ground truth of user CTCVR in the training dataset and a joint prediction of user action from the CTR neural network and user action from the CVR neural network.

The loss term L_{CVR}(θ_{cvr}) allows CVR to be emphasized in the loss function and model training. Subsection C.1 shows experiment results for performance comparison using different loss functions. Although Equation (2) shows a loss function L_{MTMS} with three loss terms having the same weight, one skilled in the art shall understand that the three loss terms may have different weights.

### 3. Embodiments of Alternative Update

In one or more embodiments, the MTMS model is a multi-task learning model. To get a proper modeling trade-off between component-specific objectives and inter-component relationships (each component is corresponding to a ranking task for a service scenario), an alternative update process for the feature representation/embedding update and the ranking network fine tuning may be adopted, as graphically shown in FIG. 3 and FIG. 5 respectively.

Embedding Update. In the time slot T, representations for input data in multiple fields under one service scenario may be learned/updated using the model shown in FIG. 3. The MTMS model comprises multiple neural networks to generate embeddings separately and independently from each field of data input under each field for each task. As shown in FIG. 3, a first neural network 312 generates a first embedding 322 from data input of a first field (e.g., user feature side) 302 for a first task (e.g., CTR prediction); a second neural network 314 generates a second embedding 324 from data input of a second field (e.g., item feature side) 304 for a second task (e.g., CVR prediction); a third neural network 316 generates a third embedding 326 from data input of the first field 302 for the first task; and a fourth neural network 318 generates a fourth embedding 328 from data input of the second field 304 for the second task. The first and second embeddings are input to a first cross-field neural network 332 to generate an output (e.g., CTR prediction) 342 for the first task. The third and fourth embeddings are input to a second cross-field neural network 334 to generate an output (e.g., CVR prediction) 344 for the second task. Finally, outputs from each task are joined together to generate the joint output or joint prediction (CTCVR) 350.

In one or more embodiments, the multiple neural networks 312, 314, 316, 318 to generate embeddings are deep neural networks, which may or may not have similar network structures. For example, the multiple neural networks may have different numbers of layers for different tasks or different fields. Similarly, the cross-field neural networks 332 and 334 are deep neural networks and may have similar or different network structures. In one or more embodiments, the multiple neural networks may be fully connected neural networks. In some real applications, user/item features may be complicated and may contain information from various sources and in different formats. Accordingly, the raw features may not be combined directly by simple fully connected perceptron. In one or more embodiments, the multiple neural networks may have multiple slots and each slot/part corresponds to a type of feature. Afterwards, the feature slots are combined together in the cross-field neural networks to get final embeddings for users and items.

FIG. 4 depicts such an embedding learning/update process for one service scenario, according to embodiments of the present disclosure. The embedding (e.g., embedding 322) of each feature field for each task under one service scenario at current time slot T are initialized (405) by those from the previous time slot T−1. In one or more embodiments, the embeddings at an initial time slot (T=0) may be initialized randomly (random real numbers). By this way, neural networks (e.g., neural networks 312, 314, 316, and 318) parameters and the embeddings (e.g., embeddings 322, 324, 326, and 328) output from the neural networks may be continually updated (410) by new coming training data in the current time slot T. During the embedding update process, embeddings (i.e., embeddings 322, 324, 326, and 328 in FIG. 3) are not shared across the neural networks (e.g., neural networks 312, 314, 316, and 318). The model may focus more on component-specific objectives and the model may be easy to converge to a better loss in a short time. Impression→click data are used to learn vectors for the CTR side and click→conversion data are exploited by the CVR network. At last, impression→click→conversion data are used for CTCVR prediction and vectors from both sides are updated. Such an embedding update process is stopped (415) when a stop condition is reached. The stop condition may be a predetermined number of updating iteration, all training data being used, the model being converged, or a loss being less than a predetermined threshold, etc.

Ranking Network Fine Tuning. Once updated embeddings are obtained for each service scenario, the ranking network may be fine-tuned as graphically shown in FIG. 5. In this stage, embeddings for each service scenario are fixed and used across model components, i.e., across ranking tasks and service scenarios. Furthermore, inter-component information may be exploited to help train the model across components in a multi-scenario system. In one or more embodiments, one cross-scene network in FIG. 5 for a task setting in MTMS may be the similar to or different from the cross-field network in FIG. 3 for similar task.

FIG. 6 depicts a process for network fine tuning with respect to FIG. 5, according to embodiments of the present disclosure. Updated embeddings obtained from each service scenario are combined (605) to generate a combined embedding for each task under each service scenario. For example, embeddings 502, 504, 506, and 508 for the first service scenario and embeddings 512, 514, 516, and 518 for the second service scenario are respectively concatenated into a concatenated embedding 521 for a first task (CTR) of the first service scenario, a concatenated embedding 522 for a second task (CVR) of the first service scenario, a concatenated embedding 523 for a first task (CTR) of the second service scenario, and a concatenated embedding 524 for a second task (CVR) of the second service scenario. In one or more embodiments, all the concatenated embeddings are the same. Each combined embedding is fed (610) into a corresponding cross-scene ranking neural network to generate a multi-scene task prediction. As shown in FIG. 5, the first cross-scene ranking neural network 531, the second cross-scene ranking neural network 532, the third cross-scene ranking neural network 533, and the fourth cross-scene ranking neural network 534 respectively receive the concatenated embedding 521, the concatenated embedding 522, the concatenated embedding 523, and the concatenated embedding 524 to generate a first multi-scene task prediction 541 (CTR1), a second multi-scene task prediction 542 (CVR1), a third multi-scene task prediction 541 (CTR2), and a fourth multi-scene task prediction 544 (CVR2). Afterwards, a MTMS prediction 550 (CTCVR) is obtained (615) based on each multi-scene task prediction. In one or more embodiments, the MTMS prediction 550 may be expressed as:

$$C T C V {R}_{M T M S} = C T C V R 1 + C T C V R 2 = C T R 1 \times CVR 1 + CTR 2 \times CVR 2 \qquad ( 3 )$$

The cross-scene ranking neural networks may then be trained (620) using an MTMS loss, e.g., Equation (2), for network parameter tuning.

In one or more embodiments, since embeddings are pre-trained independently for each service scenario, the embedding update may be done in parallel. In the ranking network fine tuning stage, embeddings from different ranking tasks and different service scenarios may be combined together to fine-tune the focus ranking networks. It may be seen that the embodiments of the presented method are much easier to be extended for more model components. In a real system with more than one hundred service scenarios, the scenarios may be modeled together using embodiments of the presented MTMS framework.

Once the MTMS model is trained, the MTMS model may be deployed to generate rankings for a plurality of recommended information, e.g., online advertisements, based on MTMS predictions for plurality of recommended information, such that the plurality of recommended information may be arranged accordingly to achieve an optimized performance, e.g., a maximum CTCVR, across multiple scenarios.

### C. Experimental Results

It shall be noted that these experiments and results are provided by way of illustration and were performed under specific conditions using a specific embodiment or embodiments; accordingly, neither these experiments nor their results shall be used to limit the scope of the disclosure of the current patent document.

In this section, embodiments of the presented methodology are evaluated. Specifically, performance of the MTMS unified ranking model is tested the in two aspects: 1) comparisons of different loss functions (subsection B.2); 2) experiments in MTMS settings. For each experiment, offline and online tests were conducted.

Evaluation Measures. For offline tests, embodiments of the MTMS unified ranking model and baselines were evaluate by the following metrics: 1) AUC; 2) mean absolute error (MAE).

In one or more experiments, the MAE may be expressed as:

$$M A E = \frac{{\sum }_{i = 1}^{N} \vert {z}_{i} - {\hat{z}}_{i} \vert}{N} \qquad ( 3 )$$

Here zᵢ is the conversion label and \hat{z}ᵢ is the predicted value of the conversion rate. For online experiments, the following measures are utilized to evaluate the presented method: 1) CVR; 2) CTCVR; and 3) opcx_target_charge, which may be expressed as:

$$opcx\_target \_charge = bid\_price \times conversions . \qquad ( 4 )$$

Experimental Data. For evaluations, data from different service scenarios of a multi-scene system were collected. Statistically, 650 millions of advertisement showing records and 14 millions of click transactions were collected in a single day. In the present patent disclosure, data collected in the period between Nov. 1, 2020 and Feb. 15, 2021 were used for experiments.

Training and Testing. To provide high quality services, embeddings pre-trained by the last 3 months' historical data were used to hot start the presented MTMS unified ranking model. After training the model based on recent three days' data, offline test was conducted by the following day's data. The testing period was not split further because user behaviors may vary across 24 hours, e.g., people may have more time for online shopping after dinner while relatively rare user data is obtained from 2 am to 6 am. It is found that one day is a good granularity for testing. If the offline performance is good, online A/B testing then runs gradually from low workload to high workload (i.e., 30%→50%→90%)

### 1. Loss Function Comparison

As analyzed in subsection B.2, CVR is explicitly modeled in the loss function. Experiments were conducted for different loss functions on offline datasets. The comparing methods comprise: 1) loss function CTR+CVR; 2) loss function CTR+CTCVR (i.e., Equation (1)); and 3) loss function CTR+CVR+CTCVR (i.e., Equation (2)). The first method modeled CTR and CVR separately. For the second and third loss functions, shared embeddings, as in ESMM (FIG. 2A), were adopted. Besides, for CTR+CVR+CTCVR, experiments for non-shared embedding were also included. Therefore, four variants were obtained.

Offline results are shown in Table 1. In MAE, all loss functions reduce the error number, comparing with the baseline (i.e., CTR+CVR). For AUC, the loss function of CTR+CTCVR even hurts the performance. On the contrary, the presented loss function (CTR+CVR+CTCVR) improves the AUC a lot, especially with the non-shared embedding design. As shown in Table 1, when the AUC number is high, e.g., larger than 0.8, explicitly modeling CVR works much better than implicitly modeling CVR.

TABLE 1
Offline performance for various loss functions.

| Loss Functions | MAE | AUC |
|---|---|---|
| CTR + CVR | 0.0443 | 0.8254 |
| Non-shared Embedding | | |
| CTR + CTCVR | 0.0449 −3.2% | 0.8240 −0.17% |
| Shared Embedding | | |
| CTR + CVR + CTCVR | 0.0440 −0.2% | 0.8269 +0.18% |
| Shared Embedding | | |
| CTR + CVR + CTCVR | 0.0429 −3.2% | 0.8281 +0.33% |
| Non-shared Embedding | | |

### 2. Main Experiments

This subsection shows experimental results for embodiments of the presented MTMS unified ranking model in the multi-task and multi-scene setting. Specifically, three methods are used for comparisons.

Baseline. The baseline models CTR and CVR separately, the same as the first method in the loss function comparison experiment. This method is trained on news feed data (i.e., only one service scenario). ESMM model is not chosen as a baseline since its offline results are worse than the baseline as shown above (see the first and second rows in Table 1).

Multi-task and One-Scene. This is a variant of the presented model, the same as the fourth variant in Table 1. It is only trained on the news feed data and does not use data from other services to help training.

Multi-task and Multi-Scene. This is the entire method of the presented model. Besides of news feed, other service scenarios are modeled together, such as video stream and search engine. For the experimental evaluation, performance for news feed service is shown only.

All methods adopt the alternative updating procedure. Multi-task learning methods with expert networks and gates (e.g., MMoE and PLE) are not considered since those methods are designed for fewer task components. In a system with hundreds of task components, those models are challenging to be fitted and the performance is dramatically bad, based on previous tests.

TABLE 2
Offline and online experimental results for
the baseline and MTMS model embodiments

| | Measures | One Scene | Multi Scene |
|---|---|---|---|
| Offline | AUC | +0.33% | +3.15% |
| | MAE | −3.2% | −5.6% |
| Online | CVR | +1.79% | +5.63% |
| | CTCVR | +0.50% | +6.00% |
| | opcx_target_charge | +2.43% | +4.78% |

Experimental results are shown in Table 2. All offline and online evaluation measures are used. Results for the baseline are not shown here. All numbers in the table are improvements comparing with the baseline. As shown in Table 2, no matter offline or online evaluations, the presented multi-task and one scene method works much better than the baseline. One reason is that the independent embeddings may help studying a proper trade-off for the multi-task settings. Besides, the newly designed loss function also helps emphasizing the CVR prediction, which is the main ranking target. The performance of the presented entire model, MTMS, is even more significantly better. In a full system, there may be more than 100 service scenarios. In this experiment, only four service scenarios (i.e., news feed, video stream and search engine) are used. As shown in Table 2, the performance of the multi-scene improved a lot, comparing to the one scene model. This demonstrates that the presented MTMS method may utilize auxiliary data in helping multi-task and multi-scene learning. Furthermore, it shall be noted that negative transfer is effectively suppressed.

### D. Some Conclusions

Multi-task learning is widely used in online advertising and recommendation, to solve the data sparsity problem. In the present patent disclosure, embodiments of a unified ranking model are presented for information recommendation, e.g., online advertising, in the case of multi-ranking tasks and multi-service scenarios. Different from previous methods, which try to exploit complex network structures to balance the task-specific objectives and inter-task relationships, the presented patent disclosure adopts a simpler model design with non-shared embeddings and an alternative updating procedure. Inter-task information is only used in ranking network fine tuning; while in the embedding updating step, the model learns representations independently for each component. The presented model is easy to be extended for more model components and is much easier to be trained. Extensive experiments demonstrated the advantages of the proposed model.

### E. Computing System Embodiments

In one or more embodiments, aspects of the present patent document may be directed to, may include, or may be implemented on one or more information handling systems (or computing systems). An information handling system/computing system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data. For example, a computing system may be or may include a personal computer (e.g., laptop), tablet computer, mobile device (e.g., personal digital assistant (PDA), smart phone, phablet, tablet, etc.), smart watch, server (e.g., blade server or rack server), a network storage device, camera, or any other suitable device and may vary in size, shape, performance, functionality, and price. The computing system may include random access memory (RAM), one or more processing resources such as a central processing unit (CPU) or hardware or software control logic, read only memory (ROM), and/or other types of memory. Additional components of the computing system may include one or more drives (e.g., hard disk drive, solid state drive, or both), one or more network ports for communicating with external devices as well as various input and output (I/O) devices, such as a keyboard, mouse, touchscreen, stylus, microphone, camera, trackpad, display, etc. The computing system may also include one or more buses operable to transmit communications between the various hardware components.

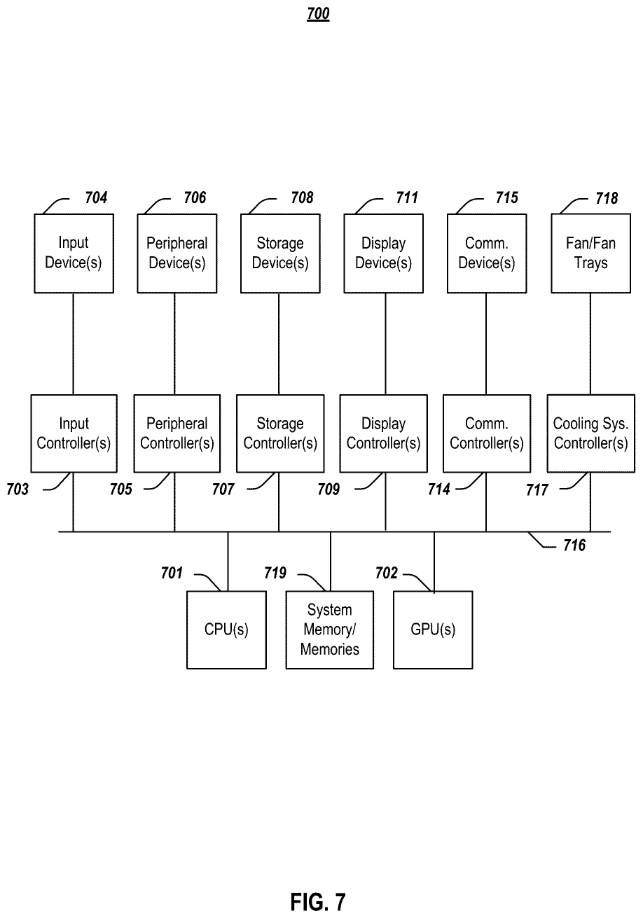

FIG. 7 depicts a simplified block diagram of an information handling system (or computing system), according to embodiments of the present disclosure. It will be understood that the functionalities shown for system 700 may operate to support various embodiments of a computing system—although it shall be understood that a computing system may be differently configured and include different components, including having fewer or more components as depicted in FIG. 7.

As illustrated in FIG. 7, the computing system 700 includes one or more CPUs 701 that provides computing resources and controls the computer. CPU 701 may be implemented with a microprocessor or the like, and may also include one or more graphics processing units (GPU) 702 and/or a floating-point coprocessor for mathematical computations. In one or more embodiments, one or more GPUs 702 may be incorporated within the display controller 709, such as part of a graphics card or cards. Thy system 700 may also include a system memory 719, which may comprise RAM, ROM, or both.

A number of controllers and peripheral devices may also be provided, as shown in FIG. 7. An input controller 703 represents an interface to various input device(s) 704. The computing system 700 may also include a storage controller 707 for interfacing with one or more storage devices 708 each of which includes a storage medium such as magnetic tape or disk, or an optical medium that might be used to record programs of instructions for operating systems, utilities, and applications, which may include embodiments of programs that implement various aspects of the present disclosure. Storage device(s) 708 may also be used to store processed data or data to be processed in accordance with the disclosure. The system 700 may also include a display controller 709 for providing an interface to a display device 711, which may be a cathode ray tube (CRT) display, a thin film transistor (TFT) display, organic light-emitting diode, electroluminescent panel, plasma panel, or any other type of display. The computing system 700 may also include one or more peripheral controllers or interfaces 705 for one or more peripherals 706. Examples of peripherals may include one or more printers, scanners, input devices, output devices, sensors, and the like. A communications controller 714 may interface with one or more communication devices 715, which enables the system 700 to connect to remote devices through any of a variety of networks including the Internet, a cloud resource (e.g., an Ethernet cloud, a Fiber Channel over Ethernet (FCOE)/Data Center Bridging (DCB) cloud, etc.), a local area network (LAN), a wide area network (WAN), a storage area network (SAN) or through any suitable electromagnetic carrier signals including infrared signals. As shown in the depicted embodiment, the computing system 700 comprises one or more fans or fan trays 718 and a cooling subsystem controller or controllers 717 that monitors thermal temperature(s) of the system 700 (or components thereof) and operates the fans/fan trays 718 to help regulate the temperature.

In the illustrated system, all major system components may connect to a bus 716, which may represent more than one physical bus. However, various system components may or may not be in physical proximity to one another. For example, input data and/or output data may be remotely transmitted from one physical location to another. In addition, programs that implement various aspects of the disclosure may be accessed from a remote location (e.g., a server) over a network. Such data and/or programs may be conveyed through any of a variety of machine-readable medium including, for example: magnetic media such as hard disks, floppy disks, and magnetic tape; optical media such as compact discs (CDs) and holographic devices; magneto-optical media; and hardware devices that are specially configured to store or to store and execute program code, such as application specific integrated circuits (ASICs), programmable logic devices (PLDs), flash memory devices, other non-volatile memory (NVM) devices (such as 3D XPoint-based devices), and ROM and RAM devices.

Aspects of the present disclosure may be encoded upon one or more non-transitory computer-readable media with instructions for one or more processors or processing units to cause steps to be performed. It shall be noted that the one or more non-transitory computer-readable media shall include volatile and/or non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present disclosure may further relate to computer products with a non-transitory, tangible computer-readable medium that have computer code thereon for performing various computer-implemented operations. The media and computer code may be those specially designed and constructed for the purposes of the present disclosure, or they may be of the kind known or available to those having skill in the relevant arts. Examples of tangible computer-readable media include, for example: magnetic media such as hard disks, floppy disks, and magnetic tape; optical media such as CDs and holographic devices; magneto-optical media; and hardware devices that are specially configured to store or to store and execute program code, such as ASICs, PLDs, flash memory devices, other non-volatile memory devices (such as 3D XPoint-based devices), and ROM and RAM devices. Examples of computer code include machine code, such as produced by a compiler, and files containing higher level code that are executed by a computer using an interpreter. Embodiments of the present disclosure may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the present disclosure. One skilled in the art will also recognize that a number of the elements described above may be physically and/or functionally separated into modules and/or sub-modules or combined together.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

1. A computer-implemented method to train a ranking model for information recommendation in a multi-task and multi-scene (MTMS) setting comprising:
receiving, at the ranking model, a training dataset across multiple scenarios, the training dataset comprises input data in multiple fields across multiple scenarios and results associated with multiple tasks;
generating, using multiple neural networks within the ranking model, embeddings independently for input data in each field for each task under each scenario;
combining embeddings across the multiple scenarios to generate a combined embedding;
generating, using multiple cross-scene ranking neural networks within the ranking model, multi-scene task predictions for the multiple tasks under the multiple scenarios, each cross-scene ranking neural network receives the combined embedding to generate a multi-scene task prediction for one task under one scenario;
obtaining an MTMS prediction based at least on each multi-scene task prediction; and
training the ranking model using an MTMS loss function, the MTMS loss function comprises at least loss terms associated with each task.

2. The computer-implemented method of claim 1 wherein the multiple fields comprise a user field and an item field.

3. The computer-implemented method of claim 1 wherein the multiple tasks comprise a first task promoting users to respond to recommended information and a second task promoting users to have a transaction corresponding to the recommended information.

4. The computer-implemented method of claim 1 wherein the MTMS prediction is a joint prediction as a product of each multi-scene task prediction.

5. The computer-implemented method of claim 4 wherein the MTMS loss function further comprises a loss term associated with the joint prediction.

6. The computer-implemented method of claim 5 wherein the loss terms associated with each task and the loss term associated with the joint prediction have the same weight in the MTMS loss function.

7. The computer-implemented method of claim 1 wherein the multiple scenarios comprise two or more scenarios selected from a group of scenarios comprising news feed, video ranking, new ranking, recommendation ranking, and search engine.

8. A computer-implemented method for training a ranking model comprising:
initializing embeddings of each feature field for each task under each scenario in a multi-task and multi-scene (MTMS) setting;
updating, until a stop condition is met, parameters of multiple neural networks within the ranking model with a training dataset to update embeddings across the multiple scenarios, the training dataset comprises input data in multiple fields under multiple scenarios and results associated with multiple tasks for each scenario;
combining the updated embeddings across multiple tasks and across the multiple scenarios to generate a combined embedding for each task under each scenario;
generating, multiple cross-scene ranking neural networks within the ranking model, multi-scene task predictions, each cross-scene ranking neural network receives one combined embedding for one task under one scenario to generate a multi-scene task prediction for the one task; and
training the ranking model using an MTMS loss function, the MTMS loss function comprises at least loss terms associated with each task.

9. The computer-implemented method of claim 8 wherein the embeddings of each feature field for each task under each scenario are updated separately and not shared across tasks during embedding updating.

10. The computer-implemented method of claim 8 wherein the stop condition is a predetermined number of updating iteration, all training data being used, the multiple neural networks being converged, or a loss being less than a predetermined threshold.

11. The computer-implemented method of claim 8 wherein the multiple fields comprise a user field and an item field.

12. The computer-implemented method of claim 8 wherein the multiple tasks comprise a first task promoting users to respond to recommended information and a second task promoting users to have a transaction corresponding to the recommended information.

13. The computer-implemented method of claim 12 wherein the MTMS loss function further comprises a loss term associated with a joint prediction, wherein the joint prediction is a product of each multi-scene task prediction.

14. A non-transitory computer-readable medium or media comprising one or more sequences of instructions which, when executed by at least one processor, causes steps for training a ranking model for information recommendation in a multi-task and multi-scene (MTMS) setting comprising:
receiving, at the ranking model, a training dataset across multiple scenarios, the training dataset comprises input data in multiple fields under multiple scenarios and results associated with multiple tasks;
generating, using multiple neural networks within the ranking model, embeddings independently for input data in each field for each task under each scenario;
combining embeddings for each task across the multiple scenarios to generate multiple combined embeddings, each combined embedding corresponds to one task under one scenario;
generating, using multiple cross-scene ranking neural networks within the ranking model, multi-scene task predictions for the multiple tasks under the multiple scenarios, each cross-scene ranking neural network receives one combined embedding to generate one multi-scene task prediction for one task under one scenario;
obtaining an MTMS prediction based at least on the multi-scene task predictions; and
training the ranking model using an MTMS loss function, the MTMS loss function comprises loss terms associated with each task.

15. The non-transitory computer-readable medium or media of claim 14 wherein the multiple combined embeddings are the same.

16. The non-transitory computer-readable medium or media of claim 14 wherein the multiple tasks comprise a first task promoting users to respond to recommended information and a second task promoting users to have a transaction corresponding to the recommended information.

17. The non-transitory computer-readable medium or media of claim 14 wherein the MTMS prediction is a joint prediction that is a product of each multi-scene task prediction.

18. The non-transitory computer-readable medium or media of claim 17 wherein the MTMS loss function further comprises a loss term associated with the joint prediction.

19. The non-transitory computer-readable medium or media of claim 18 wherein the loss terms associated with each task and the loss term associated with the joint prediction have the same weight in the MTMS loss function.

20. The non-transitory computer-readable medium or media of claim 14 wherein the multiple scenarios comprise two or more scenarios selected from a group of scenarios comprising news feed, video ranking, new ranking, recommendation ranking, and search engine.
